(19) United States
(12) Patent Application Publication
(10) Pub. No.: US 2020/0372354 A1
(43) Pub. Date: Nov. 26, 2020

(54) Feature shaping system for learning features for deep learning

(71) Applicant: Johannes Schneider, Frastanz (AT)

(72) Inventor: Johannes Schneider, Frastanz (AT)

(21) Appl. No.: 16/882,460

(22) Filed: May 23, 2020

Related U.S. Application Data
(60) Provisional application No. 62/852,985, filed on May 25, 2019.

(51) Int. Cl. G06N 3/08; G06N 3/04

(52) U.S. Cl. CPC G06N 3/08; G06F 17/18; G06N 3/0472

(57) ABSTRACT

Systems and methods are disclosed for shaping features in a neural networks. In particular, in one or more embodiments, the disclosed systems and methods train a neural network by altering each parameter of a feature differently using one or multiple shaping parameters for each feature parameter. Moreover, in one or more embodiments, the disclosed systems and methods utilize L2-regularization and shared feature shaping parameters to learn features. Furthermore, in one or more embodiments, the disclosed systems and methods utilize correlated initialization for spatial parameters and initializing spatial parameters with different expected standard deviation.

### BACKGROUND OF THE INVENTION

The present invention is in the technical field of machine learning systems. More particularly, the present invention is in the technical field of deep learning systems, and therein in the sub-field of convolutional neural networks (CNN).

Machine learning systems have many applications, eg. image classification and speech recognition. Machine learning allows to extract knowledge from historical data automatically to make decisions, eg. to classify objects. A decision refers to fixing an output, such as predicting a class (classification), number (regression) or newly constructed sample (autoencoder). It partially automates the work of domain experts that explicitly encode rules or features. Features also called representations, filters or kernels in CNNs are used in the decision making process. Deep learning is a machine learning technique that is loosely inspired by the human brain. In contrast to other machine learning techniques it learns better representations without human expertise. It learns from examples, eg. training data. However, in the last 30 years there has been limited success in improving how individual features are to be learnt. Improvements have largely been made on a higher, ie. architectural level. This holds, in particular, for convolutional neural networks, which perform a sort of pattern (or feature) matching. For example, the well-known ResNet architecture introduces shortcuts, connecting lower with higher layers. Another architecture called inception creates layers that contain filters of different spatial dimensions. The current state-of-the-art treats each part of a feature, given by parameters to be learnt, uniformly. A visual feature might be thought of as a template, eg. features of a face might be an ear, a nose, a mouth etc. A feature constitutes of parameters (also called weights). A feature consists of one or several spatial features. In particular, if the input is two dimensional a spatial feature has a width and a height. Convolutional neural networks learn such templates automatically from the data in a trial and error manner, eg. most commonly using backpropagation. That is to say, that for a given input sample an output is computed and parameters are then adjusted based on how good the output for the input sample is (measured by a loss function). Thus, the network learns by repeatedly updating parameters using sets of data samples, typically a small subset of all available data (a batch) is chosen for each parameter update. In this learning process, representations might be constrained. That is, deep learning systems utilize multiple mechanisms (such as dropout or L2-regularization) to ensure that decisions are made based on multiple criteria rather than just one, eg. an object should not be classified as car only because it has 4 tyres, but also if other criteria are fulfilled (or features are present) such as the existence of an engine. However, all of these mechanisms and architectures, treat the parameters making up a feature uniformly. That is to say, a feature, ie. its parameters, are learnt in a way that does not give preference to any parameter. For instance, current regularization mechanisms treat the most central parameter of a spatial feature equivalently to a parameter in a corner. Regularization mechanisms such as L1 and L2 are mostly defined by a single parameter and rarely based on using a distinct parameter per layer. The current state-of-the-art often gives features that are instable, ie. different features might be learnt using the same network and initial conditions but with small differences in the data. Interpretability of features might be hard. Features might be difficult to locate, that is to say that the learnt features are such that often times there are multiple, possible nearby, locations where the features appear to be equally strongly present. Furthermore, also strength estimates are often imprecise. Poor localization might also impact strength estimates, since features are learnt in hierarchies. That is to say, if the deep learning system recognized all components of a face, eg. eyes, mouth, hair etc. but it estimates their locations wrongly, a feature for detecting faces that utilizes the strength of the components and their locations might fail to detect the face. Furthermore, the learning requires large amounts of data. In short, there is considerable improvement possible for learning representations in convolutional neural networks by treating parameters of a feature differently. The referred process is a form of feature shaping beyond ordinary backpropagation based on single batches.

### SUMMARY OF THE INVENTION

Introduced here are techniques/technology to learn features in convolutional neural networks that lead to better performance. In particular, in one or more embodiments, systems and methods shaping (or adjusting) features are given. An important aspect is that individual parts, ie. weights, of the features undergo different levels of shaping—even if they have the same values. Shaping might be determined based on information from trained networks or by allowing for larger weights near the center of a feature. The outcome of the learning of features are likely features that are more stable in terms of their location estimate and lead to better performance of the network. For example, in one or more embodiments, the disclosed systems and methods utilize one or several trained neural networks to derive shaping parameters for learning features by computing means of parameters at different distances from the center. In another example, in one or more embodiments, the disclosed systems and methods utilize irregular, meaning non-uniform across locations, regularization for learning features, ie. treating parameters at different locations of a feature differently. That is to say, for regularization, regularization parameters might be chosen, so that they reduce some parameters of a feature more than others, even if the feature parameters have the same value. Specifically, the disclosed systems and methods might encourage parameters of features close to the center to be larger, eg. using shaping mechanisms such as regularization or explicit confinement of parameters to intervals or both.

### BRIEF DESCRIPTION OF THE DRAWINGS

FIG. 1 is a schematic diagram of the feature shaping system and its components in accordance with one or more embodiments;

FIG. 2 illustrates inputs and outputs of the shaping parameter estimation engine in the form of a sequence diagram in accordance with one or more embodiments;

FIG. 3 illustrates inputs and outputs of the shaping application engine in the form of a sequence diagram in accordance with one or more embodiments;

FIG. 4 is a flow chart of the feature shaping system with intertwined estimation of feature parameters and feature shaping parameters in accordance with one or more embodiments;

FIG. 5 is an illustration of feature shaping parameters for one feature comprising of multiple spatial features and using the same shaping parameters across all spatial features in accordance with one or more embodiments;

FIG. 6 is an illustration of a convolutional neural network in accordance with one or more embodiments;

FIG. 7 is source code for estimating shaping parameters and specifying L2 regularization loss terms in accordance with one or more embodiments;

FIG. 8 is source code for computing a correlated initialization of a single spatial feature;

### DETAILED DESCRIPTION OF THE INVENTION

One or more embodiments of the present disclosure include learning features, ie. adjusting feature parameters. More particularly, the feature shaping system can identify suitable shaping parameters, e.g. in the form of regularization parameters or fixed intervals, that might depend, for example, on the network architecture, the layer in the network, parameters of already learnt networks or initial values of feature parameters. For example, in one or more embodiments, the feature shaping system trains one or several neural networks based on any neural network architecture utilizing digital training data. Based on the learnt parameters, it derives shaping parameter, e.g. constraints or regularization parameters. These constraints or regularization parameters are used in subsequent trainings of a neural network. In particular, in one or several embodiments features might be shaped to increase cohesiveness.

By shaping features, features are obtained that improve performance metrics of neural networks such as accuracy for image or text classification. Features might be shaped so that they increase emphasis on sub-features close to their center more.

As used herein, a “neural network” consists of a sequence of layers. The layers represent a hierarchy of features. That is, each “feature” is composed of multiple sub-features. Each feature is represented by a set of parameters that are learnt during the training process of the neural network. Each parameter represents the importance or relevance of a sub-feature, eg. a feature in a lower layer of the feature hierarchy. A “spatial feature” has spatial dimensions such as width, height. Parameter or sub-features can be distinguished based on their locations within the spatial feature. That is, commonly each parameter can be assigned with a unique location. For example, a sub-feature in the center is fully surrounded by other sub-features. A sub-feature at the corner is not fully surrounded by other sub-features. For a three dimensional feature there are width times height times depth locations. Depending on the network architecture, a feature is the union of one or multiple spatial features. Often the number of spatial dimensions equals the number of input features. For an input to the network the evaluation of the network, yields a “feature map” for each feature. In convolutional neural networks, the inputs are often of spatial dimension two and, thus, a feature map computed using a feature is often two dimensional with the same width and height as the input or smaller. For texts, it is often one dimensional. A feature map indicates the strength of the feature at a specific location of the input. Feature strength estimates might change gradually when considering nearby locations in a feature map or abruptly.

Training of a neural network refers to an iterative process including special processing steps at the beginning or end of the process, such as initialization before training or feature pruning after training. In each iteration the network is presented a set of training samples. Depending on the performance (measured by a loss function) on the training samples updates of the parameters are done in each iteration. An iteration might involve choosing any subset of all training samples. A batch herein refers to any possible subset of the training data. A loss function encompasses as an objective directly related to overall performance (such as accuracy for classification). It might also contain regularization terms to achieve secondary goals that in the end benefit overall performance.

A network of a particular architecture might be trained multiple times leading to a set of trained networks that differ due to variation of initial feature parameters or training modalities. Each feature of the un-trained network and each parameter of a feature are assigned a unique label in an arbitrary manner. This allows to match features for different trained networks.

As used herein, “shaping of a feature” refers to mechanisms that alters the parameters of a feature. Shaping encompasses, for example, constraining, regularizing, initialization or direct manipulation. Shaping is a mechanism that reduces or sets preferences for the possible set of values parameters of a feature. In particular, different parameters of the same feature might be subject to a different degree of shaping. A simple constraint might enforce a parameter to stay within a specific value range during training. Initialization refers to setting the value of a feature before training begins. Initialization is typically done using random values stemming from the same distribution for each layer. Initialization as defined herein refers to use distributions that might also depend on the location within a spatial filter. For example, features near the center, might obtain larger (expected) values or standard deviations or both. Direct manipulation refers to adjusting feature parameters in a non-iterative manner, one-shot manner. Direct manipulation, might, for example, increase all weights in the center by some percentage and decrease all others. Shaping can be applied before the iterative training, during the iterative raining and after the iterative training of a neural network. Before iterative training shaping might refer to setting initial parameters. “Regularizing a feature” refers to a mechanism that adds a term to the loss function of a neural network. Regularization parameters, defining for example the strength of regularization, might be different for each parameter of a feature. Therefore, “shaping of a feature” might require a set of parameters, potentially, multiple parameters for each parameter of a feature. “Feature shaping parameters” refers to parameters that are utilized to shape features during training but not during later phases, where the network is used for the purpose it was trained, ie. classification.

In one or more embodiments of the present disclosure, the system estimates feature shaping parameters that are used for regularization.

In one or more embodiments of the present disclosure, the system estimates feature shaping parameters that are used for initialization.

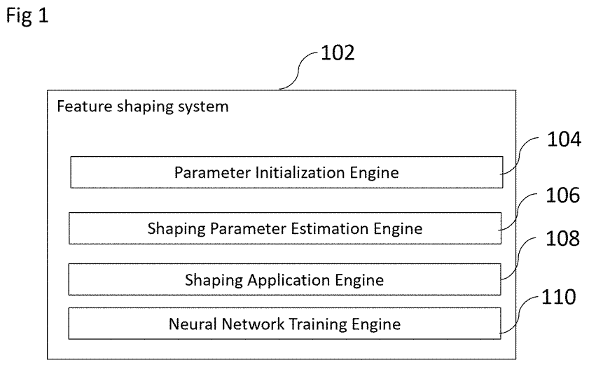

FIG. 1 shows the feature shaping system and its four components 102. The parameter initialization engine 104 provides initial parameter values for features that are later updated. The shaping estimation engine 106 computes information that is needed for shaping of features. The shaping application engine 108 shapes features by modifying their parameters. The neural network training engine 110 trains a neural network.

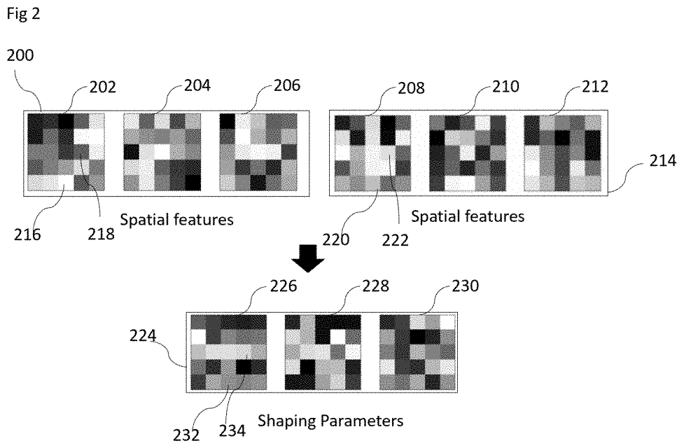

FIG. 2. shows one embodiment of the shaping estimation engine 106. The shaping estimation engine takes as input sets of spatial features 200 and 214 and outputs shaping parameters 224. Each spatial feature 202 204 206 208 210 212 is represented by a matrix of values. In FIG. 2 each spatial feature consists of width 5 and height 5 giving 25 parameter values. For illustrative purposes values are coded using gray tunes. That is, the bright square 216 in spatial feature 202 signifies a large value and the darker square 218 signifies a smaller value. For spatial feature 202 the parameter 218 is nearer to the center of the spatial feature than the parameter 216.

The shaping parameters 224 consists of information for shaping for spatial features that is 226 contains information for one spatial feature, 228 for a second spatial feature and 230 for a third spatial feature.

In one embodiment the spatial features 200 stem from one trained neural network and the spatial features 214 from another trained neural network. That is, the same architecture trained with different initial feature parameters or training modalities. Spatial features 202 and 208 resemble the same feature, ie. having the same unique label, but stemming from two different trained networks. Say 200 stems from trained network A and 214 from trained network B. The parameter 216 and the parameter 220 resemble the same parameter, ie. having the same unique label, but 216 stems from trained network A and 220 from trained network B. The spatial features 204 and 210 also resemble the same feature, again 204 from network A and 210 from network B. 224 contains shaping parameters 226, 228 and 230. These shaping parameters are applied to training a third network C. So that 226 might refer to shaping parameters for the feature with the label indicated by feature 202 in C, shaping parameters 228 are for feature with label given by feature 204 in C.

In another embodiment the spatial features 200 stem from one iteration of the training process of a neural network and spatial features 214 stem from the same network but another iteration. Spatial features 202 and 208 resemble the same feature at two different iterations of the learning process. The parameter 216 and the parameter 220 resemble the same parameter but at two different iterations. So does 218 and 222. The spatial features 204 and 210 also resemble the same feature at different iterations as well as 206 and 212. That is, 226 contains information for spatial feature 208, 228 for 210 and 230 for 212.

In 226 shaping information contains only a single feature shaping parameter for each feature parameter. In another embodiment it consists of more than one value. The value in 232 provides restriction information for 220, eg. L2-regularization parameters.

In one or more embodiments feature shaping parameters are shared. That is the same feature shaping parameter is used for multiple feature parameters. In one embodiment, the same feature shaping parameters are used for all locations with the same distance of the center for spatial features of a layer. For illustration, all corners of spatial features of equal dimensions of one layer might be regularized using the same shaping parameters. In another embodiment, features of a layer might be grouped based on feature similarity. For each group the same shaping parameters are used. In another embodiment, feature shaping parameters for a feature are a weighted average of feature shaping parameters shared for a group features and feature parameters derived specifically for the feature.

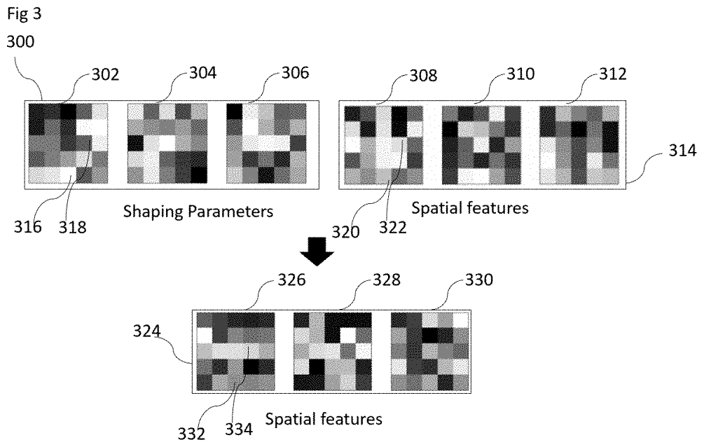

FIG. 3. shows one embodiment of the shaping application engine 108. The shaping application engine takes as input shaping parameters 300 and spatial feature parameters 314. It outputs updated spatial feature parameters 324, which are a result of applying the feature shaping parameters 300 to the spatial feature parameters 314. Thus, spatial features 308 and 326 refer to the same features, ie. with the same label, but likely altered values due to updating process. Likewise, 310 and 328 refer to the same feature and so does 306 and 312. Shaping parameters 302 are used to shape feature 308, shaping parameters 304 are used to shape feature 310 and shaping parameters 306 are used to shape features 312.

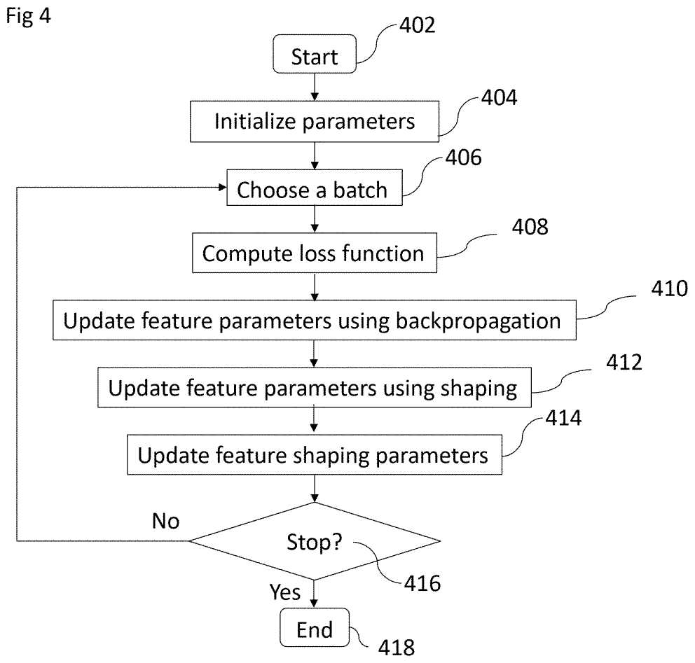

FIG. 4. shows one embodiment of the feature shaping system. At the start 402 a network architecture including layers, shapes of filters and number of filters per layer is available. Parameters of the network such as feature parameters as well as feature shaping parameters are initialized 404. In one embodiment feature shaping parameters are initialized uniformly. In one embodiment they are initialized using the same distributions but different expected values. In one embodiment initial values are chosen to be spatially correlated. In one embodiment they are initialized using different distributions. Steps 406 to 416 describe on iteration of the training. Step 406 refers to choosing a batch of all training samples. This batch is used for computing the loss function 408 that is being optimized. The loss (per sample) is then utilized to update feature parameters using backpropagation 410. Feature parameters are also updated using feature shaping 412. In one embodiment a L2-regularization loss based on feature shaping parameters is computed and feature parameters are updated using the L2-loss. Feature shaping parameters are then updated 414. In one embodiment, they are based on a weighted mean of existing feature shaping parameters and current feature parameters. In another embodiment, the weighted mean is additionally altered so that weights in the center of a feature are shaped to be larger. Another iteration of the training is performed, if the stopping condition is not met.

In one embodiment of the feature shaping system in FIG. 4 before the initializing of parameters 404, one or multiple networks of the same architecture are trained without feature shaping. The trained models are then used to extract values for the feature shaping parameters. These values are used to initialize the feature shaping parameters. In one embodiment the initial shaping parameters are not adjusted any more throughout the training. That is to say, step 414 is not executed.

In one embodiment of the feature shaping system in FIG. 4 a set S of spatial features is added to form a single spatial feature. Each spatial feature F in S is regularized differently. In one embodiment, the set S consists of 3 spatial filters each of width 3 and height 3. For one spatial feature, the center parameter and the parameters left and right of the center are regularized significantly stronger than all six other parameters. For another spatial feature, the center parameter, the parameters above and below the center are regularized significantly stronger than all six other parameters.

In one embodiment of the feature initialization system 104 a set S of spatial features is added to form a single spatial feature. Each spatial feature F in S is initialized differently. In one embodiment, the set S consists of 3 spatial filters each of width 3 and height 3. For one spatial feature, the center parameter and the parameters left and right of the center are initialized significantly larger in expectation than all six other parameters. For another spatial feature, the center parameter, the parameters above and below the center are initialized significantly larger in expectation than all six other parameters.

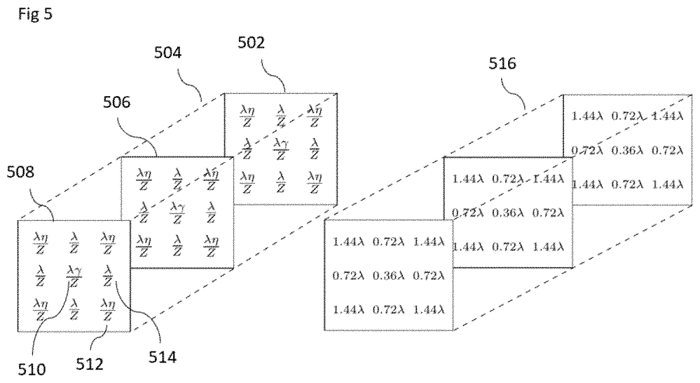

FIG. 5 shows one embodiment for feature shaping parameter sharing using L1- or L2 regularization for regularizing spatial features. There are three feature shaping values indicated by the formulas 510 512 514. They are used to regularize all feature parameters for all three spatial features 504 506 508. The feature shaping values 510 512 514 are based on three feature shaping parameters lambda(λ), eta(η) and gamma(γ). The value Z is the normalization constant that depends on some of these parameters. Lambda is an overall regularization constant for all spatial features 504 506 508. Each spatial feature is represented by a separate 3 times 3 matrix of parameters denoted by w=(w_{i,j}), where i,j in {0,1,2}. For each spatial feature a regularization loss can be added to the overall loss as stated here:

$$LOCO \text{-} REG Loss \text{:=} {L}_{2}^{Reg \_ Loss} ( {w}_{i , j} ) = \frac{λ}{Z} ( γ {w}_{1 , 1}^{2} + {\sum }_{( i , j ) ∈ {I}_{n}} {w}_{i , j}^{2} + {\sum }_{( i , j ) ∈ {I}_{ea}} η {w}_{i , j}^{2} ) \\ Z \text{:=} \frac{γ + 4 ( 1 + η )}{9} {I}_{n} \text{:=} \{ ( 0 , 1 ) , ( 1 , 0 ) , ( 1 , 2 ) , ( 2 , 1 ) \} {I}_{co} \text{:=} \{ ( 0 , 0 ) , ( 2 , 0 ) , ( 0 , 2 ) , ( 2 , 2 ) \} \qquad ( 1 )$$

Numerical values 516 illustrate 502. These values can, for instance, be set manually or be part of an optimization process.

One embodiment of FIG. 4 using one or multiple networks of the same architecture for feature shaping parameter estimation of FIG. 5 can be described as follows. There is a set of trained networks M. Each spatial feature consists of a 3 times 3 matrix of parameters denoted by w=(w_{i,j}), where i,j in {0,1,2}. All spatial features in layer I of a single network are denoted by W_{I}. The parameters gamma and eta are computed per layer, thus the subscript in the formulas below. The parameter c, is a tuning parameter that can be set to 1.5 or any other value so as to optimize network performance.

$$m ( w , I ) \text{:=} \frac{{Σ}_{( i , j ) ∈ I} {w}_{i , j}}{\vert I \vert} \{ Mean of weights with indexes I \}$$

Ratios for layer l averaged across trained models M:

$$r ( M , l , I , {I}^{′} ) \text{:=} \frac{1}{\vert M \vert} {\sum }_{{W}_{i} ∈ M} \frac{{Σ}_{w ∈ {W}_{l}} m ( w , I )}{{Σ}_{w ∈ {W}_{l}} m ( w , {I}^{′} )}$$

$$a ( r , c ) \text{:=} 1 + c ( r - 1 ) \{ Modulate deviations of r from 1 \}$$

$$( {γ}_{l} , {η}_{l} ) \text{:=} ( a ( r ( M , l , {I}_{n} , {I}_{c} ) , 1.5 ) , \frac{1}{a ( r ( M , l , {I}_{n} , {I}_{co} ) , 1.5 )} )$$

In one or more embodiments, the feature shaping system utilizes a fully convolutional neural network. In particular, in one or more embodiments, the feature shaping system utilizes a fully convolutional network as described in K. Simonyan and A. Zisserman. “Very deep convolutional networks for large-scale image recognition”, Int. Conference on Learning Representations (ICLR), 2014 or in F. Landola, M. Moskewicz, S. Karayev, R. Girshick, T. Darrell, and K. Keutzer. “Densenet: Implementing efficient convnet descriptor pyramids”, 2014 or in K. He, X. Zhang, S. Ren, and J. Sun. “Deep residual learning for image recognition”, Conference on computer vision and pattern recognition (CVPR), 2016 or in F. Chollet or “Xception: Deep learning with depthwise separable convolutions”, conference on Computer Vision and Pattern Recognition (CVPR), 2017. These architectures exhibit significant differences in their detailed implementation.

As illustrated, the convolutional neural network (CNN) 600 takes training input 602 and through a series of applied layers, generates an output, eg. class probabilities for a classification task. In particular, the CNN 600 utilizes a plurality of convolution layers 604, a plurality of Re—Lu layers 606, a plurality of pooling layers 608, and a softmax layer and a loss layer 316. Utilizing these layers, the CNN 600 generates the output, which is then measured against a ground truth and used for backpropagation. Additionally, such architectures can contain Batchnormalization or Dropout layers.

Convolution Layer 604: The convolution layer 604 is the basic layer which applies a number of convolutional kernels. The convolutional kernels are trained to extract important features from the images such as edges, corners or other informative region representations.

Re-LU Layers 606: The Re-LU is a nonlinear activation to the input. The function is f(x)=max(0,x). This nonlinearity helps the network computing nontrivial solutions on the training data.

Pooling Layers 608: The pooling layers 608 compute the max or average value of a particular feature over a region in order to reduce the features spatial variance.

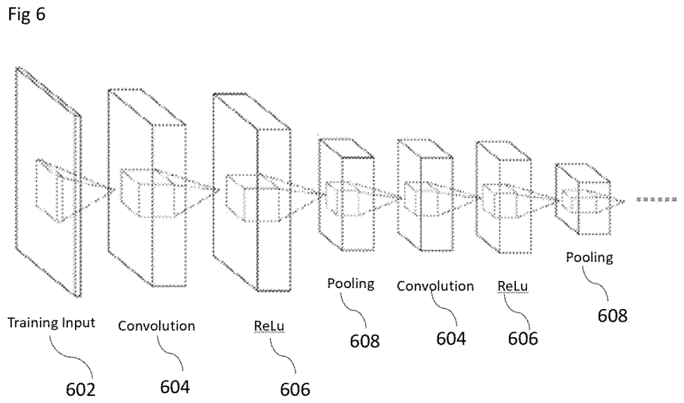

As a final layer in FIG. 6 the network contains a loss layer. The loss layer measures the error between the output of the network and the ground truth. For a classification task, the loss layer is computed by a Softmax function.

These layers can be combined to networks for a variety of computer vision tasks such as semantic segmentation, classification, and detection. It will be appreciated that subsequent convolution and pooling layers incrementally trade spatial information for semantic information.

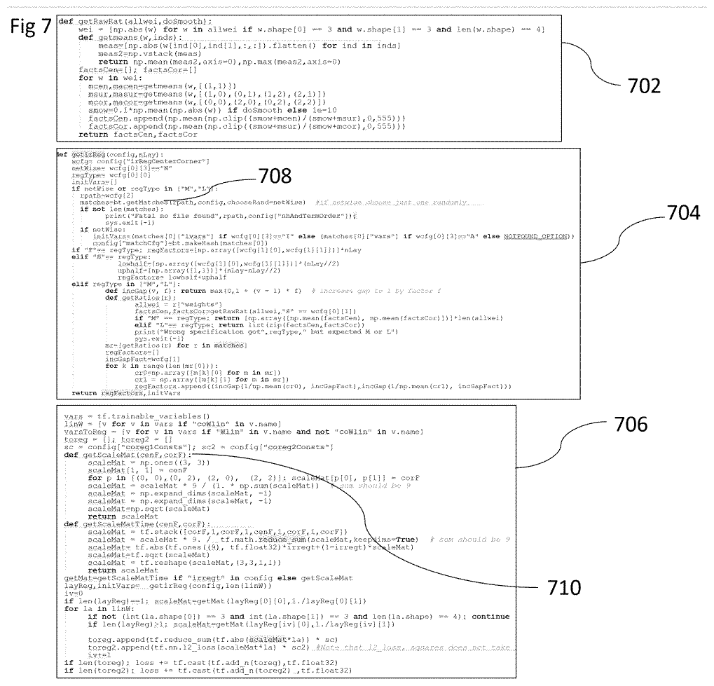

FIG. 7 shows source code written in Python 3.6 based on TensorFlow r1.13. It illustrates multiple embodiments of the feature shaping system. It utilizes a “config” variable that allows to specify different variations of implementation. It uses a global regularization parameter for all layers “sc2” for L2 regularization corresponding to lambda(λ) in FIG. 5, and a global parameter for L1 regularization “sc1”. One or more embodiments use fixed shaping parameters that are part of the input as parameters eta(η) and gamma(γ) as in FIG. 5 for all layers. One or more embodiments adjust eta(η) and gamma(γ) per layer based on pre-trained networks. Multiple pre-trained networks are loaded from a storage device 708 and then feature shaping parameters eta(η) and gamma(γ) per layer are computed 704 utilizing function 702. For the feature shaping parameter application 706 L1- and L2-regularization are utilized by adding them to the loss function.

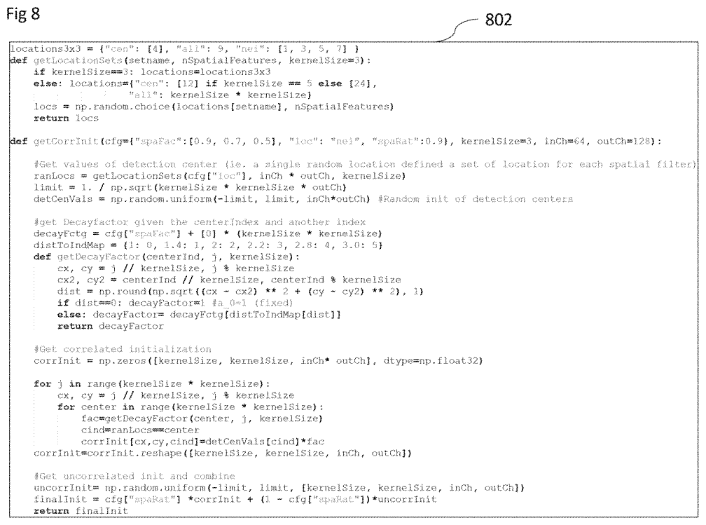

FIG. 8 shows source code written in Python 3.6 based on TensorFlow r1.13. It illustrates multiple embodiments of the feature initialization system 104. The function “getCorrInit” in FIG. 8 utilizes a “config” variable that allows to specify different variations of implementation. It allows to initialize parameters near the center with larger values then near the boundary (using “loc”:“cen”) by choosing spatial factors that correspond to scaling factors of different locations of the spatial filter (using “spaFac”:[factor1,factor2,factor3]). For a filter of width 3 and height 3, first, the random value v as initial value for the center parameter is chosen. The parameters to the left, right, above and below the center are initialized to the chosen value v scaled by factor1. The parameters at the corner are initialized to the value v scaled by factor2. Furthermore, the degree of correlation of the parameters is adjustable. That is, the obtained correlated values for initialization might be combined with uncorrelated values for initialization.

In one embodiment, the feature shaping system utilizes DropConnect instead or in addition to L2-regularization. It utilizes one feature shaping parameter for each feature parameter stating the probability to drop the parameter.

Those skilled in the art will appreciate that the disclosure may be based on multiple deep learning architectures such as VGG, ResNet and Inception, DenseNet, MobileNet and using multiple regularization mechanisms such as L1, L2 or dropconnect, it maybe implemented using personal computers, desktop computers, laptop computers, message processors, hand-held devices, multi processor systems, microprocessor-based or programmable consumer electronics, network PCs, minicomputers, main frame computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. All changes that come within the meaning and range of equivalency of the appended claims are to be embraced within their scope.

1) A method for deep learning to improve learning of features, the method comprising:
initialization, training, by at least one processor, a neural network utilizing training input generated from a repository of training data;
generating, by at least one processor, one or more features by shaping parameters from different sets of feature parameters differently and parameters from the same group in the same manner.

2) The method of claim 1, wherein:
generating one or more features further comprises regularizing sets of feature parameters in the same manner, wherein each group consists of weights of features at one or more spatial locations of one or more layers.

3) The method of claim 1, wherein:
generating one or more features further comprises estimating feature shaping parameters

4) The method of claim 3, wherein:
estimating feature shaping parameters further comprises using one or more pre-trained networks

5) The method of claim 3, wherein:
estimating feature shaping parameters further comprises updating feature shaping parameters during iterative learning process using feature shaping parameters from prior iterations and feature parameters from prior iterations

6) The method of claim 2, wherein:
regularizing groups of features further comprises of adding Lp-norm regularization terms to the loss function.

7) The method of claim 2, wherein:
feature parameters in the center are regularized less strongly than feature parameters near the boundary of the feature.

8) The method of claim 1, wherein:
generating one or more features further comprises confining all weights to be within fixed intervals.

9) The method of claim 8, wherein:
generating one or more features further comprises confining weights closer to the center to intervals with larger lower bound, lower upper bound or both, than weights close to the border.

10) The method of claim 1, wherein:
generating one or more features further comprises initializing parameters of spatial features correlated.

11) The method of claim 1, wherein:
generating one or more features further comprises initializing parameters of spatial features differently.

12) The method of claim 11, wherein:
generating one or more features further comprises initializing parameters of spatial features with varying expected values or standard deviations or both.
